(19) United States
(12) Patent Application Publication
(10) Pub. No.: US 2007/0062229 A1
(43) Pub. Date: Mar. 22, 2007

(54) Key for immobilizer

(75) Inventors: Kazuhiro Miyata, Miyazaki (JP); Takeo Mizukoshi, Saitama (JP)

Correspondence Address: CARRIER BLACKMAN AND ASSOCIATES, 24101 NOVI ROAD, SUITE 100, NOVI, MI, 48375, US

(73) Assignees: Kabushiki Kaisha Honda Lock, Miyazaki-shi (JP); Honda Motor Co., Ltd., Tokyo (JP)

(21) Appl. No.: 11/522,061

(22) Filed: Sep. 15, 2006

(30) Foreign Application Priority Data
Sep. 22, 2005 (JP) 2005-275169

(51) Int. Cl. E05B 19/04

(52) U.S. Cl. 70/408

(57) ABSTRACT

A key for an immobilizer, includes: a mechanical key part including a key plate capable of being inserted into a cylinder lock, and a key head coupled to one end of the key plate; and a grasping case which supports the key head so that the mechanical key part can be displaced between a housed position in which the entire mechanical key part is housed in the grasping case and a protruding position in which the key plate protrudes out of the grasping case. A transponder for transmitting a particular ID code signal to the cylinder lock is built in the key head. Thus, the cylinder lock can be unlocked by only the mechanical key part which has been fallen off from the grasping case.

### CROSS-REFERENCE TO RELATED APPLICATIONS

The present invention claims priority under 35 U.S.C. 119 based on Japanese patent application No. 2005-275169, filed on Sep. 22, 2005. The subject matter of this priority document is incorporated by reference herein.

### BACKGROUND OF THE INVENTION

1. Field of the Invention

The present invention relates to a key for an immobilizer used in an immobilizer system, comprising: a mechanical key part including a key plate capable of being inserted into a cylinder lock, and a key head coupled to one end of the key plate; and a grasping case which supports the key head so that the mechanical key part can be displaced between a housed position in which the entire mechanical key part is housed in the grasping case and a protruding position in which the key plate protrudes out of the grasping case.

2. Description of the Related Art

U.S. Pat. No. 6,705,141 discloses a key for an immobilizer wherein a key head of a mechanical key part is supported in a grasping case having a transponder built therein so that the mechanical key part can be displaced between a housed position in which the entire mechanical key part is housed in the grasping case and a protruding position in which a key plate protrudes out of the grasping case.

In the key disclosed in this patent, however, if the mechanical key part is fallen off from the grasping case due to a cause such as the fracture of the grasping case, it is difficult to unlock the cylinder lock by only the mechanical key part which does not have the transponder, because the transponder is built in the grasping case.

### SUMMARY OF THE INVENTION

Accordingly, it is an object of the present invention to provide a key for an immobilizer wherein a cylinder lock can be unlocked by only a mechanical key part which has been fallen off from the grasping case.

In order to achieve the above object, according to the present invention, there is provided a key for an immobilizer, comprising: a mechanical key part including a key plate capable of being inserted into a cylinder lock, and a key head coupled to one end of the key plate; and a grasping case which supports the key head so that the mechanical key part can be displaced between a housed position in which the entire mechanical key part is housed in the grasping case and a protruding position in which the key plate protrudes out of the grasping case, wherein a transponder for transmitting a particular ID code signal to the cylinder lock is built in the key head.

With the above arrangement of the present invention, even when the mechanical key part has been fallen off from the grasping case due to a cause such as the fracture of the grasping case, the transmission and reception of the signal can be performed between the mechanical key part and the cylinder lock, and the cylinder lock can be unlocked by only the mechanical key part, because the transponder is built in the key head of the mechanical key part.

The above and other objects, features and advantages of the invention will become apparent from the following description of the preferred embodiment taken in conjunction with the accompanying drawings.

### BRIEF DESCRIPTION OF THE DRAWINGS

FIG. 1 is a side view of a key for an immobilizer according to an embodiment of the present invention in a state in which a mechanical key part is in a protruding position.

FIG. 2 is a side view of the key for the immobilizer in a state in which the mechanical key part is in a housed position.

FIG. 3 is a view taken in the direction of an arrow 3 in FIG. 2.

FIG. 4 is a side view of the mechanical key part taken from a side opposite from the viewpoint of FIG. 1.

FIG. 5 is a sectional view taken along a line 5-5 in FIG. 4.

FIG. 6 is a vertical sectional view showing a state in which the key for the immobilizer has been inserted into a cylinder lock.

FIG. 7 is an exploded perspective view of the key for the immobilizer.

FIG. 8 is a sectional view taken along a line 8-8 in FIG. 1.

FIG. 9 is an enlarged view of a portion indicated by an arrow 9 in FIG. 8.

FIG. 10 is a sectional view taken along a line 10-10 in FIG. 9.

### DETAILED DESCRIPTION OF THE PREFERRED EMBODIMENT

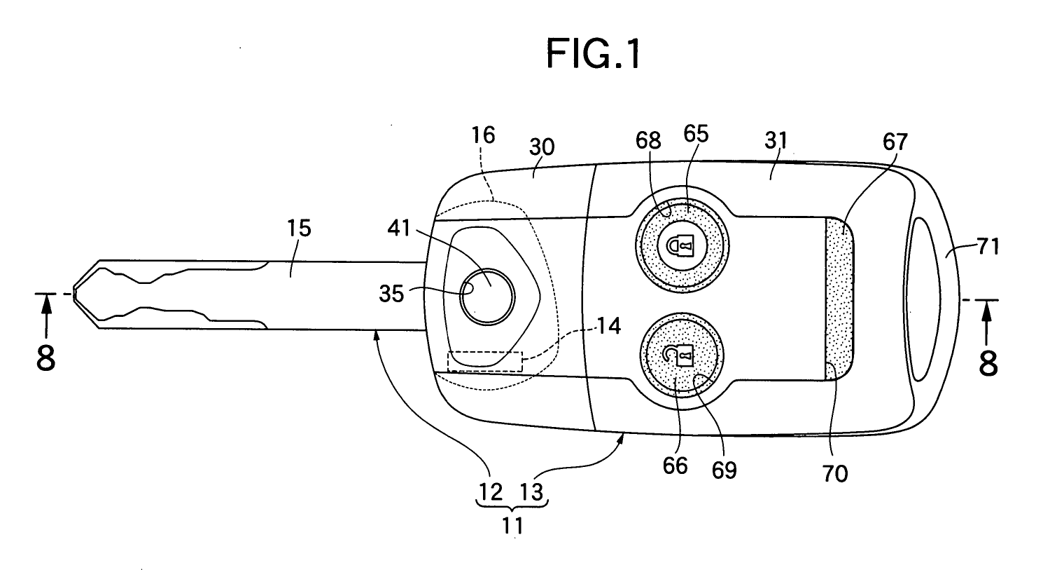

Referring first to FIGS. 1 to 3, a key 11 for an immobilizer includes: a mechanical key part 12; a grasping case 13 which supports the mechanical key part 12 so that the mechanical key part 12 can be turned between a housed position in which the entire mechanical key part 12 is housed in the grasping case 13, and a protruding position in which a portion of the mechanical key part 12 protrudes out of the grasping case 13; and a transponder 14.

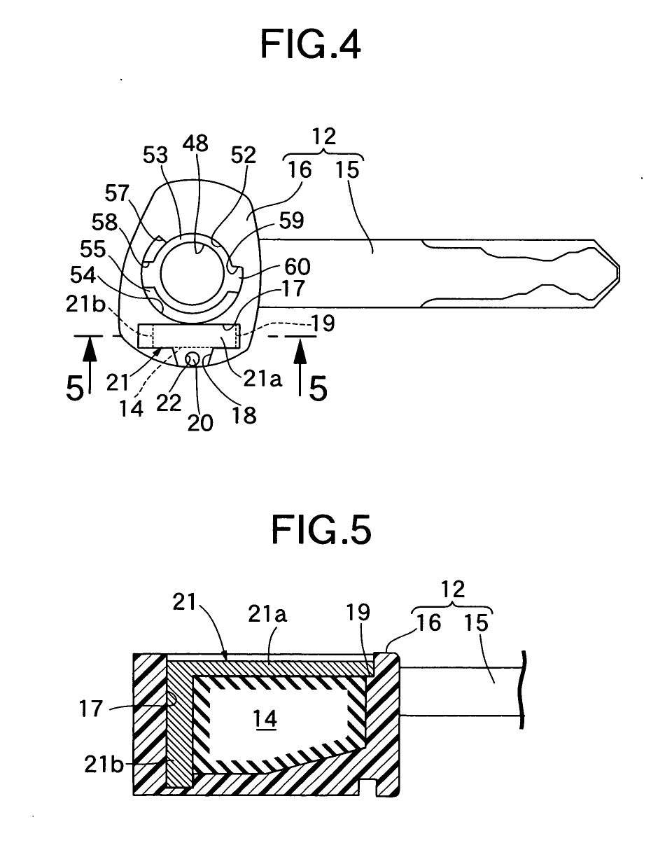

Referring to FIGS. 4 and 5, the mechanical key part 12 comprises a key plate 15 made of a metal, and a key head 16 coupled to one end of the key plate 15. The key head 16 is formed from a synthetic resin in such a manner that one end of the key plate 15 is inserted into and coupled to the key head 16. Moreover, a rectangular accommodating recess 17 is provided in the key plate 16 so that the recess 17 extends long in parallel with a lengthwise direction of the key plate 15 to open in one side of the key head 16. A positioning recess 18 is provided in the key head 16 so that the recess 18 leads to a lengthwise intermediate portion of the accommodating recess 17 to open in the one side and an outer periphery of the key head 16. The positioning recess 18 is formed to be shallower than the accommodating recess 17. An outward facing step 19 is formed at lengthwise one end of the accommodating recess 17 on the same level as a bottom surface of the positioning recess 17. A positioning projection 20 is projectingly provided at a central portion of the positioning recess 17.

The transponder 14 is accommodated in the accommodating recess 17. A retaining member 21 is bonded to the key head 16 so as to retain the transponder 14 within the accommodating recess 17. The retaining member 21 is formed into a substantially L-shape, and integrally has a lid portion 21a formed into a shape corresponding to the accommodating recess 17 and the positioning recess 18, and a leg portion 21b connected at a right angle to the lid portion 21a. The lid portion 21a abuts against the step 19 and the positioning recess 18 to cover the accommodating recess 17. The leg portion 21b protrudes into the accommodating recess 17 in such a manner that it is interposed between the lengthwise other end of the accommodating recess 17 and the transponder 14. Moreover, the lid portion 21a is provided with a positioning bore 22 into which the positioning projection 20 is fitted.

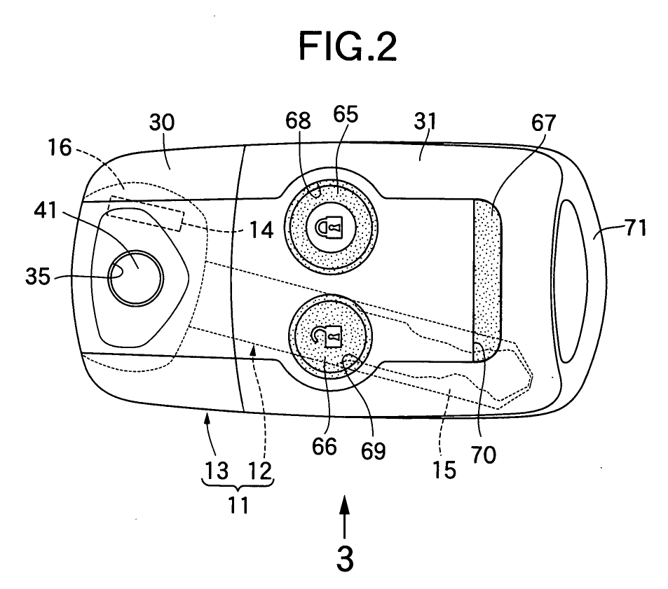

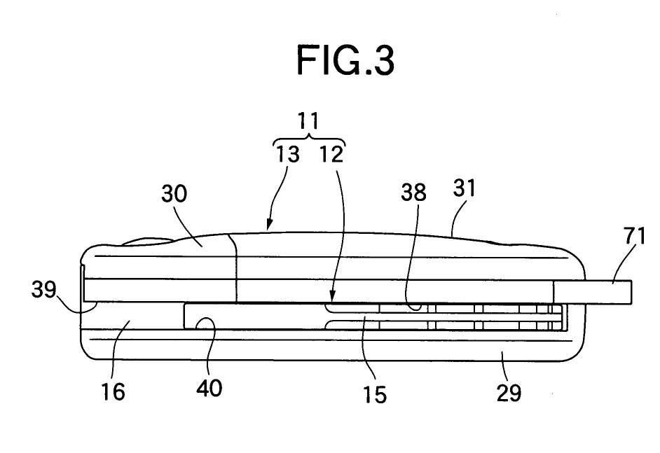

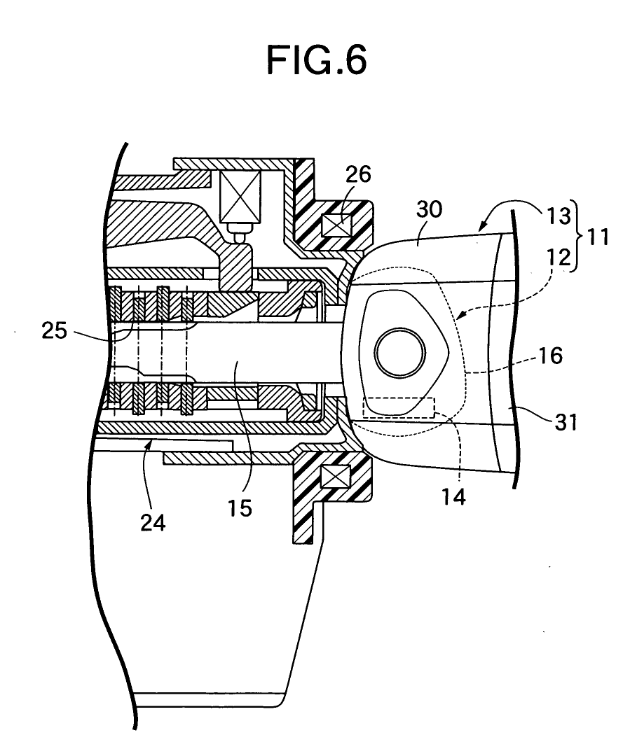

The key head 16 of the mechanical key part 12 is supported in the grasping case 13 in such a manner that it is turned between the housed position (the position shown in FIGS. 2 and 3) in which the entire mechanical key part 12 is housed in the grasping case 13, and the protruding position (position shown in FIG. 1) in which the key plate 15 of the mechanical key part 12 protrudes out of the grasping case 13. As shown in FIG. 6, the key plate 15 in the state of protruding out of the grasping case 13 is inserted into a keyhole 25 in a cylinder lock 24 which is adapted to switch the locking and unlocking of a steering wheel of a vehicle and to switch an engine on and off. When the key plate 15 is inserted into the keyhole 25, the transponder 14 transmits a particular ID signal upon reception of magnetism from a coil 26 mounted at a front end of the cylinder lock 24; and if an ID cord of the ID signal is confirmed to be identical with a preset ID cord on the side of the cylinder lock 24, the operation of unlocking the cylinder lock 24 by the key 11 for an immobilizer is allowed.

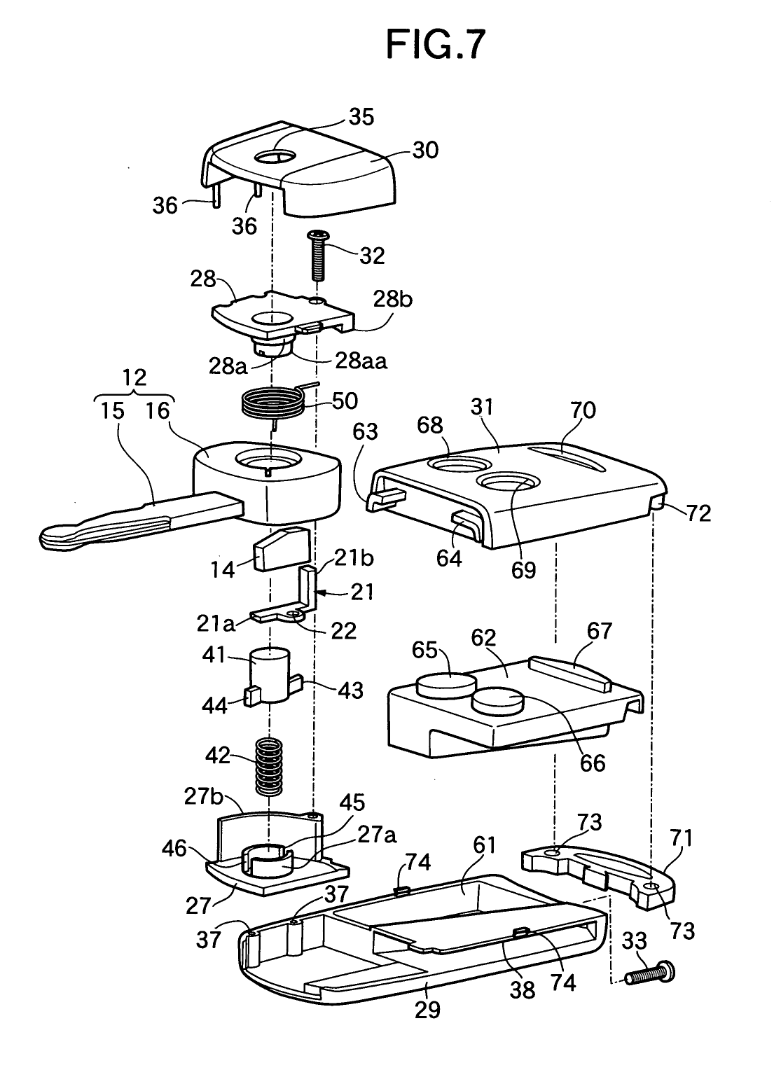

Referring also to FIGS. 7 to 9, the grasping case 13 includes: a lower case part 27 formed of a light metal such as a zinc alloy; an upper case part 28 formed of a light metal such as a zinc alloy and coupled to the lower case part 27 by a screw member 32; a module case part 29 which is formed of a synthetic resin and to one end of which the lower case portion 27 is inserted and coupled; a cover 30 made of a synthetic resin and ultrasonic-welded to the module case part 29 to cover the upper case part 28; and a module cover 31 made of a synthetic resin and engaged with and fastened to the module case part 29 by a screw member 33.

The lower case part 27 is integrally provided with: a first cylindrical supporting tube portion 27a protruding toward the upper case part 28; and a guide wall portion 27b having an arcuate sectional shape and surrounding a portion of the first supporting tube portion 27a. The upper case part 28 is integrally provided with: a second supporting tube portion 28a which is formed into a stepped cylindrical shape with axially opposite ends opened and which protrudes toward the lower case part 27 so as to have a small-diameter tubular portion 28aa at its protruding end; and a guide wall portion 28b having an arcuate sectional shape and surrounding a portion of the second supporting tube portion 28a. The upper case part 28 is fastened to the guide wall portion 27b of the lower case part 27 by a screw member 32 in a state in which a tip end of the small-diameter tubular portion 28aa of the second support tube portion 28a is fitted into an end of the first supporting tube portion 27a on the upper case part 28 side, and the guide wall portions 27b and 28b are in abutment against each other.

Thus, the first and second supporting tube portions 27a and 28a fitted and connected to each other are passed through a central portion of the key head 16 of the mechanical key part 12. The key head 16 clamped between the lower case part 27 and the upper case part 28 can be turned about axes of the first and second supporting tube portions 27a and 28a in such a manner that a portion of each of their outer peripheries is brought into sliding contact with corresponding one of the guide wall portions 27b and 28b in a connected state.

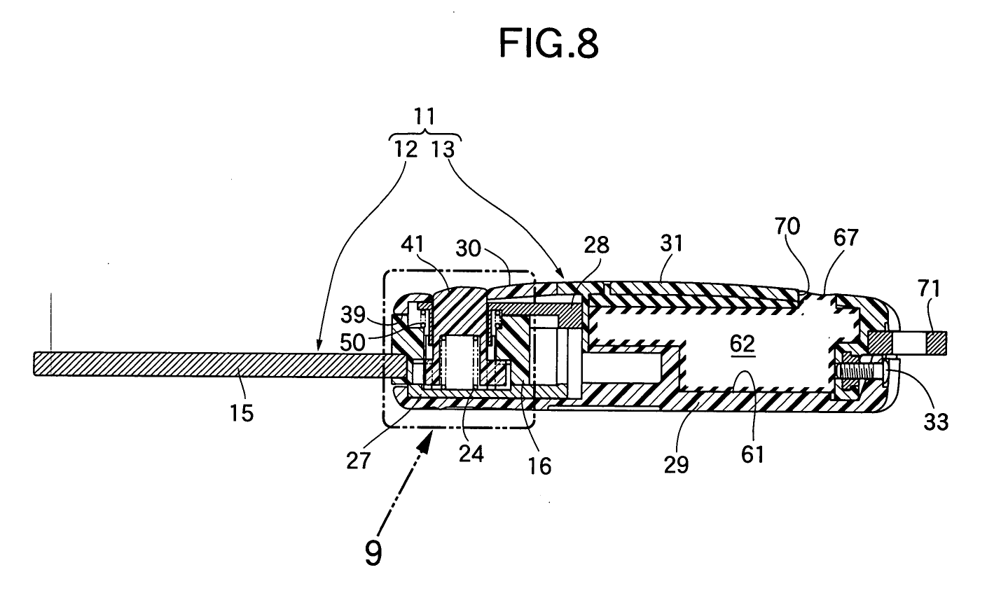

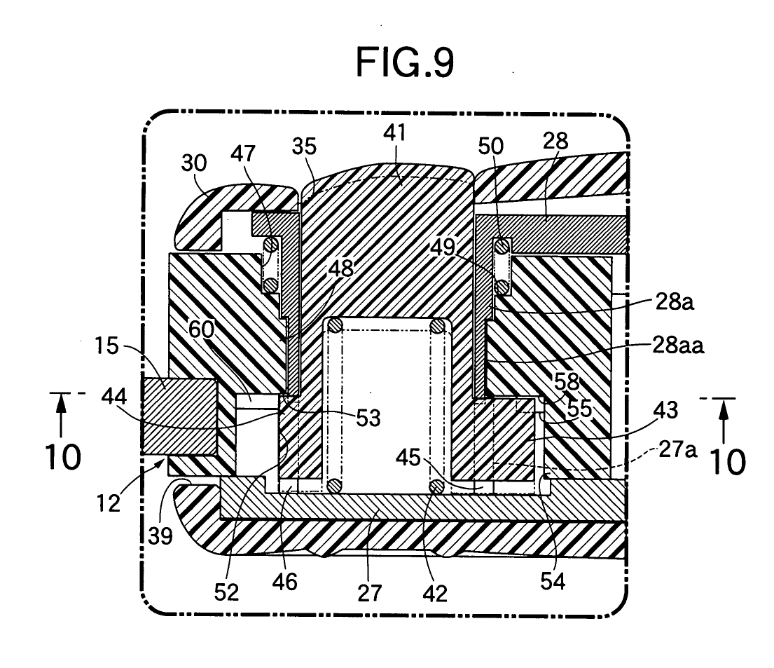

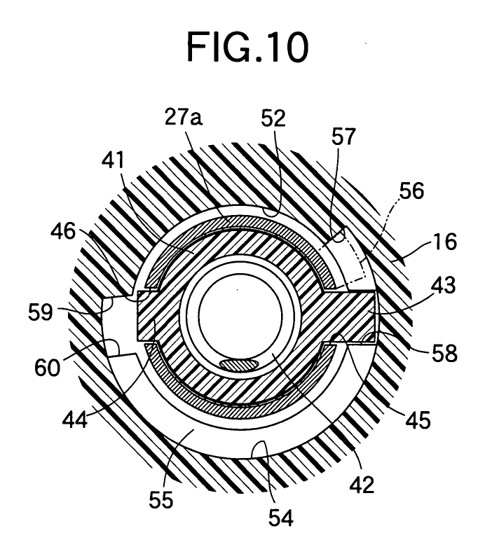

The cover 30 is provided with a window 35 corresponding to an opening in an upper end of the second supporting tube portion 28a of the upper case part 28. A pair of positioning pins 36, 36 are projectingly provided in the cover 30 so as to be fitted respectively into a pair of positioning bores 37, 37 provided in the module case part 29. The cover 30 and the module case part 29 are ultrasonic-welded to each other in a state in which the positioning pins 36 are fitted into the positioning bores 37. Moreover, a recess 38 is provided in one side of the module case part 29 and adapted to accommodate the key plate 15 when the mechanical key part 12 is in the housed position. Formed between one end of the module case part 29 and the cover 30 are an opening 39 (see FIGS. 8 and 9) which faces a portion of the outer periphery of the key head 16 of the mechanical key part 12, and a guiding slit 40 (see FIG. 3) which connects together the opening 39 and the recess 38 so as to allow the movement of the key plate 15 when the mechanical key part 12 is turned between the housed position and the protruding position.

A release button 41 is vertically movably inserted into the first supporting tube portion 27a and the second supporting tube portion 28a. The release button 41 is formed into a bottomed cylindrical shape so that a hemispherical closed portion at its upper end faces the window 35. A coil spring 42 is mounted under compression between the lower case part 27 and the release button 41 so as to bias the release button 41 upwards, i.e., in a direction away from the lower case part 27. First and second restricting projections 43 and 44 are integrally provided on an outer periphery of the release button 41 on the lower case part 27 side so as to protrude outwards along one diametrical direction of the release button 41. On the other hand, first and second restricting bores 45 and 46 each extending axially in a slit-shape are provided in a lower end of the small-diameter tubular portion 28aa of the second supporting tube portion 28a and the first supporting tube portion 27a. Thus, the fitting of the restricting projections 43 and 44 into the restricting bores 45 and 46 ensures that the release button 41 inserted into the defining bores 45 and 46 is permitted to move axially within a limited range, and that the release button 41 is prevented from rotating within the first and second supporting tube portions 27a and 28a.

A spring accommodating bore 47 is provided in a central portion of the key head 16 of the mechanical key part 12 to surround a base end of the second supporting tube portion 28a so that its one end opens in a side of the key head 16 on the upper case part 28 side. A supporting bore 48 formed into a stepped shape is provided in the key head 16 so that a portion of the second supporting tube portion 28a in the vicinity of the small-diameter tubular portion 28aa is fitted into the supporting bore 48 to rotatably support the key head 16. One end of the support bore 48 is coaxially connected to the other end of the spring accommodating bore 47. An annular step 49 is formed between the spring accommodating bore 47 and the supporting bore 48 to face the upper case part 28. A torsion spring 50 is disposed between the step 49 and the upper case part 28 to surround the base end of the second supporting tube portion 28a in such a manner that the torsion spring 50 is accommodated in the spring accommodating bore 47. Opposite ends of the torsion spring 50 are engaged with the upper case part 29 and the key head 16, respectively. The torsion spring 50 exhibits a spring force for biasing the key head 16 and thus the mechanical key part 12 in a direction of turning from the housed position to the protruding position.

Referring also to FIG. 10, an insertion bore 52 is coaxially provided in the key head 16 with its one end coaxially leading to the other end of the supporting bore 48 in such a manner that an annular step 53, against which the tip end of the first supporting tube portion 27a abuts, is formed between the insertion bore 52 and the supporting bore 48, and that the insertion bore 52 surrounds the first supporting tube portion 27a. The other end of the insertion bore 52 opens in a side of the key head on the lower case part 27 side. An arcuate guide recess 54 is provided in the key head 16 in such a manner that a portion of an inner periphery of the insertion bore 52 is enlarged. The arcuate guide recess 54 is adapted to permit the first restricting projection 43 having the tip end protruding from the first supporting tube portion 27a to turn relative to the key head 16, when the mechanical key part 12 is turned between the housed position and the protruding position. An arcuate slide-contact step 55 is formed between the insertion bore 52 and the guide recess 54 so that the first restricting projection 43 is brought into sliding contact with the step 55.

Moreover, circumferentially one end of the guide recess 54 is formed as a first restricting face 57, against which a projection 56 projectingly provided at a position on the outer periphery of the first supporting tube portion 27a adjacent to the first restricting bore 45 is put into abutment. Therefore, an end of turning, to the protruding position, of the mechanical key part 12 biased by the torsion spring 50 to the protruding position, is defined by the abutment of the first restricting face 57 against the projection 56 of the first supporting tube portion 27a. In addition, a first fitting recess 58 is provided in the slide-contact step 55 in the vicinity of the first restricting face 57 so that the first restricting projection 43 is fitted into the first fitting recess 58. When the release button 41 is brought into a natural state in which no external force is applied to the release button 41 in a state in which the mechanical key part 12 is in the protruding position as a result of the abutment of the first restricting face 57 against the projection 56 of the first supporting tube portion 27a, the first restricting projection 43 of the release button 41 biased by the coil spring 42 is fitted into the first fitting recess 58, whereby the attitude of the mechanical key part 12 in the protruding position is retained.

The circumferentially other end of the guide recess 54 is formed as a second restricting face 59, against which the first restricting projection 43 abuts in the housed position of the mechanical key part 12. A second fitting recess 60 is provided in the circumferentially other end of the slide-contact step 55 so that the first restricting projection 43 in abutment against the second restricting face 59 is fitted into the second fitting recess 60. Thus, when the release button 41 is brought into a natural state in which no external force is applied to the release button 41 in a state in which the mechanical key part 12 is in the housed position as a result of the abutment of the second restricting face 59 against the first restricting projection 43, the first restricting projection 43 of the release button 41 biased by the coil spring 42 is fitted into the second fitting recess 60, whereby the attitude of the mechanical key part 12 in the housed position is retained.

In order to turn the mechanical key part 12 from the housed position to the protruding position, an operator merely releases his hand after pushing-in of the release button 41 facing the window 35 against the spring force of the coil spring 42. This permits the key head 16 of the mechanical key part 12 to be automatically turned to the protruding position by the spring force of the torsion spring 50, while bringing the first restricting projection 43 disengaged from the second fitting recess 60 into sliding contact with the slide-contact step 55. In the protruding position, the release button 41 is pushed out by the coil spring 42 so that the first restricting projection 43 is fitted into the first fitting recess 58. Thus, the attitude of the mechanical key part 12 in the protruding position is retained by virtue of the fitting of the first restricting projection 43 in the first fitting recess 58.

In order to return the mechanical key part 12 from the protruding position to the housed position, the operator merely pushes in the release button 41 facing the window 35 against the spring force of the coil spring 42 at an initial stage of the turning operation. This enables the release button 58 to be manually turned to the housed position, while bringing the first restricting projection 43 disengaged from the fitting recess 58 into sliding contact with the slide-contact step 55. In the housed position, the release button 41 is pushed out by the coil spring 42 so that the first restricting projection 43 is fitted into the second fitting recess 60. Thus, the attitude of the mechanical key part 12 in the housed position is retained by virtue of the fitting of the first restricting projection 43 in the second fitting recess 60.

Referring particularly carefully to FIG. 7, a module recess 61 opening toward the module cover 31 is provided in the module case part 29 adjacent to the recess 38 which accommodates the key plate 15 of the mechanical key part 12 in the housed position. A keyless module 62 is accommodated in the module recess 61. A pair of engagement projections 63 and 64 are projectingly provided on the module cover 31 so that they are disengageably engaged with the cover 30. A pair of engagement claws 74, 74 are projectingly provided on opposite sides of the module case part 29 so as to resiliently engage opposite inner sides of the module cover 31. Thus, the module cover 31 is fastened to the module case part 29 by the screw member 33 to cover the keyless module 62 by bringing the engagement projections 63 and 64 into engagement with the cover 30 and bringing the engagement claws 74 of the module case 29 into engagement with the module cover 31.

The keyless module 62 includes a locking button 65, an unlocking button 66 and a panic button 67. The keyless module 62 is constructed so as to output a signal for automatically locking a door lock mechanism by pushing of the locking button 65; output a signal for automatically unlocking the door lock mechanism by pushing the unlocking button 66; and output a signal for urging a warning operation on the side of an automobile by pushing the panic button 67. The buttons 65, 66 and 67 are disposed to face windows 68, 69 and 70 provided in the module cover 31.

Further, a holder ring 71 is clamped between the module case part 29 and the module cover 31 in such a manner that its majority protrudes out of the grasping case 13. A pair of pins 72 projectingly provided on the module cover 29 are fitted into a pair of fitting bores 73 provided in the holder ring 71.

The operation of this embodiment will be described below. The mechanical key part 12 comprises: the key plate 15 capable of being inserted into the cylinder lock 24; and the key head 16 coupled to the one end of the key plate 15. The key head 16 of the mechanical key part 12 is supported in the grasping case 13 so as to turn between the housed position in which the entire mechanical key part 12 is housed in the grasping case 13 and the protruding position in which the key plate 15 protrudes out of the grasping case. The transponder 14 for transmitting the particular ID cord signal to the cylinder lock 24 is built in the key head 16.

Therefore, even when the mechanical key part 12 is fallen off from the grasping case 13 due to a cause such as the fracture of the grasping case 13, the transmission and reception of the signal between the mechanical key part 12 and the cylinder lock 24 can be achieved by only the mechanical key part 12, and the unlocking of the cylinder lock 24 can be carried out by only the mechanical key part 12, because the transponder 14 is built in the key head 16 of the mechanical key part 12.

Although the embodiment of the present invention has been described in detail, the present invention is not limited to the above-described embodiment, and various modifications in design may be made without departing from the scope of the invention defined in the claims.

What is claimed is:

1. A key for an immobilizer, comprising:
a mechanical key part including a key plate capable of being inserted into a cylinder lock, and a key head coupled to one end of the key plate; and
a grasping case which supports the key head so that the mechanical key part can be displaced between a housed position in which the entire mechanical key part is housed in the grasping case and a protruding position in which the key plate protrudes out of the grasping case,
wherein a transponder for transmitting a particular ID code signal to the cylinder lock is built in the key head.
